(19) United States
(12) Patent Application Publication
(10) Pub. No.: US 2023/0274901 A1
(43) Pub. Date: Aug. 31, 2023

(54) ELECTROMAGNETIC RELAY

(71) Applicant: OMRON Corporation, Kyoto-shi (JP)

(72) Inventors: Ayaka MIYAKE, Kyoto-shi (JP); Kazuhiro TSUTSUI, Kyoto-shi (JP); Hiroyuki TANAKA, Kyoto-shi (JP)

(21) Appl. No.: 18/106,939

(22) Filed: Feb. 7, 2023

(30) Foreign Application Priority Data
Feb. 25, 2022 (JP) 2022-027950

(51) Int. Cl. H01H 50/56; H01H 50/14

(52) U.S. Cl. CPC H01H 50/56; H01H 50/14

(57) ABSTRACT

An electromagnetic relay includes a fixed terminal, a base, a fixed contact, a movable contact, a movable contact piece, and a movable terminal. The base supports the fixed terminal. The fixed contact is connected to the fixed terminal. The movable contact faces the fixed contact. The movable contact is connected to the movable contact piece. The movable terminal is provided separately from the movable contact piece and supported by the base. The movable terminal includes a support portion. The support portion is connected to the movable contact piece below the movable contact and supports the movable contact piece. The support portion includes an upper edge and a recess. The recess has a shape recessed downward from the upper edge at a position overlapping the movable contact piece.

### CROSS-REFERENCE TO RELATED APPLICATION

This application claims priority to Japanese Patent Application No. 2022-027950, filed Feb. 25, 2022. The contents of that application are incorporated by reference herein in their entirety.

### FIELD

The present invention relates to an electromagnetic relay.

### BACKGROUND

An electromagnetic relay includes a movable contact piece. A movable contact is connected to the movable contact piece. The movable contact piece is made of an elastic conductive material such as copper. The movable contact piece is elastically deformed by being pressed by a pressing member such as a card. The movable contact is thereby moved.

For example, in the electromagnetic relay disclosed in JP-A-2000-348592, the movable contact piece is connected to a movable terminal provided separately from the movable contact piece. The movable terminal is fixed to a base. The movable contact piece is connected to the movable terminal at a position below the movable contact and extends upward from the movable terminal.

### SUMMARY

In order to secure a spring constant that satisfies the electrical switching performance of the electromagnetic relay in the movable contact piece, it is required to secure the length of the portion of the movable contact piece that can be elastically deformed by pressing with the pressing member. This elastically deformable portion is the portion of the movable contact piece that extends upward from the movable terminal. However, if the elastically deformable portion becomes longer, the electromagnetic relay becomes larger in the vertical direction. It is an object of the present invention to extend a length of an elastically deformable portion of a movable contact piece while suppressing an increase in a size of an electromagnetic relay in a vertical direction.

An electromagnetic relay according to one aspect of the present invention includes a fixed terminal, a base, a fixed contact, a movable contact, a movable contact piece, and a movable terminal. The base supports the fixed terminal. The fixed contact is connected to the fixed terminal. The movable contact faces the fixed contact. The movable contact is connected to the movable contact piece. The movable terminal is provided separately from the movable contact piece and supported by the base. The movable terminal includes a support portion. The support portion is connected to the movable contact piece below the movable contact and supports the movable contact piece. The support portion includes an upper edge and a recess. The recess has a shape recessed downward from the upper edge at a position overlapping the movable contact piece.

In the electromagnetic relay according to the present aspect, the support portion of the movable terminal includes the recess at the position overlapping the movable contact piece. Therefore, the length of the elastically deformable portion of the movable contact piece is increased while suppressing an increase in the height of the movable contact piece with respect to the base. As a result, the length of the elastically deformable portion of the movable contact piece is increased while suppressing an increase in the size of the electromagnetic relay in the vertical direction.

The width of the recess may be greater than the width of the movable contact piece at a position overlapping the recess. In this case, the movable contact piece is likely to be elastically deformed without being interfered with by the movable terminal.

The support portion may include a first protrusion. The first protrusion may be disposed on one side of the recess and protrude upward from the recess. In this case, the rigidity of the support portion is improved compared to a case where the entire support portion becomes smaller in the vertical direction.

The first protrusion may include a flat first upper end. In this case, when fixing the movable terminal to the base, the first upper end can be stably pushed by a jig.

The support portion may include a second protrusion. The second protrusion may be disposed on the other side of the recess and protrude upward from the recess. In this case, the rigidity of the support portion is improved compared to a case where the entire support portion becomes smaller in the vertical direction.

The second protrusion may include a flat second upper end. In this case, when fixing the movable terminal to the base, the second upper end can be stably pushed by a jig.

The base may include a bottom surface, a stand portion, and a concave groove. The stand portion may protrude downward from the bottom surface. The concave groove may be disposed above the stand portion and have a downwardly recessed shape. The support portion may be disposed in the concave groove. In this case, the depth of the concave groove can be increased. As a result, the length of the elastically deformable portion of the movable contact piece is increased while suppressing an increase in the height of the movable contact piece relative to the base.

The movable contact piece may include a bent portion. The movable contact piece may have a plurality of bent shapes at the bent portion. The bend portion may be disposed to face the recess. In this case, the length of the portion of the movable contact piece above the bent portion is increased. As a result, the length of the elastically deformable portion of the movable contact piece is increased while suppressing an increase in the size of the electromagnetic relay in the vertical direction.

A portion of the movable contact piece above the bent portion may be inclined toward the fixed contact. In this case, since the movable contact piece has a bent shape, the contact force between the movable contact and the fixed contact can be obtained by the elastic force of the movable contact piece.

### BRIEF DESCRIPTION OF THE DRAWING

FIG. 1 is a perspective view of an electromagnetic relay according to an embodiment.

FIG. 2 is a side view of the electromagnetic relay.

FIG. 3 is an enlarged side sectional view of the electromagnetic relay.

FIG. 4 is an enlarged side sectional view of the electromagnetic relay.

FIG. 5 is a perspective view of a movable contact piece and a movable terminal.

FIG. 6 is a front view of the movable contact piece and the movable terminal.

FIG. 7 is a side view of the movable terminal and the movable contact piece.

### DETAILED DESCRIPTION

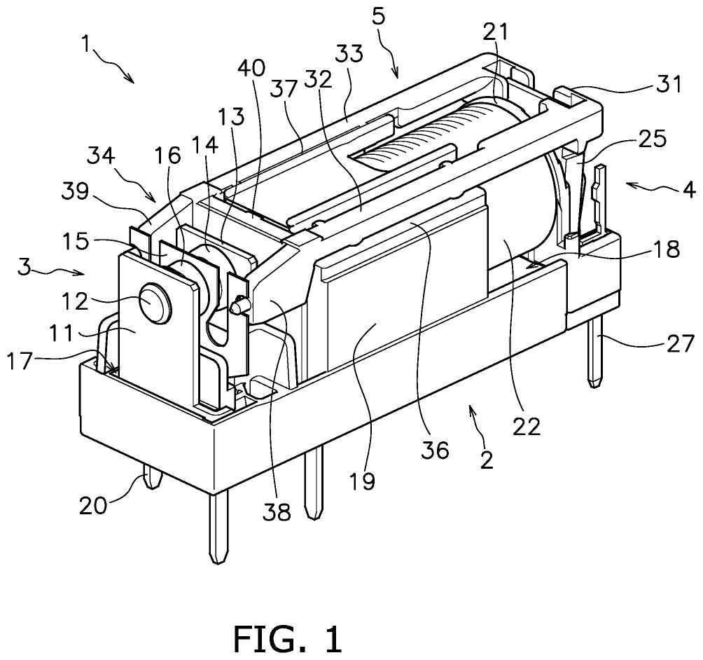

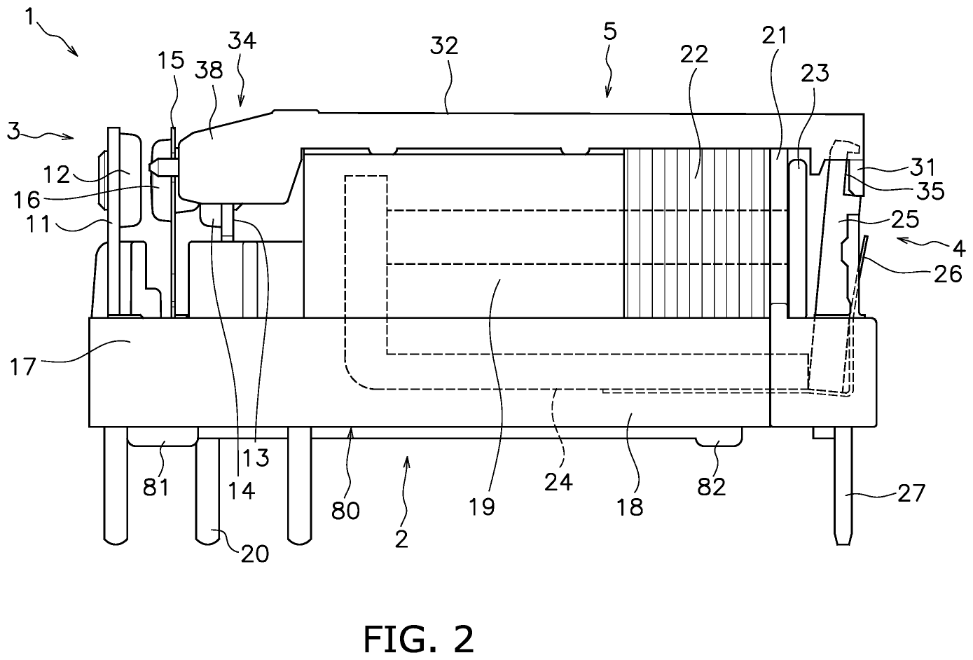

Hereinafter, an electromagnetic relay according to an embodiment will be described with reference to the drawings. FIG. 1 is a perspective view of an electromagnetic relay 1 according to an embodiment. FIG. 2 is a side view of the electromagnetic relay 1. As shown in FIGS. 1 and 2, the electromagnetic relay 1 includes a base 2, a contact device 3, a coil block 4, and a card 5.

The base 2 supports the contact the device 3, the coil block 4, and the card 5. The base 2 is made of resin. The base 2 is covered with a case (not shown). The contact device 3 includes a first fixed terminal 11, a first fixed contact 12, a second fixed terminal 13, a second fixed contact 14, a movable contact piece 15, a movable contact 16, and a movable terminal 20.

The first fixed terminal 11, the second fixed terminal 13, the movable contact piece 15, and the movable terminal 20 are made of conductive metal such as copper. The first fixed terminal 11, the second fixed terminal 13, and the movable terminal 20 are supported by the base 2. The first fixed terminal 11, the second fixed terminal 13, and the movable terminal 20 protrude outside the base 2 through the base 2. The base 2 includes a terminal support portion 17. The first fixed terminal 11, the second fixed terminal 13, and the movable terminal 20 are passed through holes provided in the terminal support portion 17. The first fixed terminal 11, the second fixed terminal 13, and the movable terminal 20 are fixed to the base 2 by, for example, press fitting or adhesion.

The first fixed contact 12 is connected to the first fixed terminal 11. The second fixed contact 14 is connected to the second fixed terminal 13. The movable terminal 20 is connected to the movable contact piece 15. The movable contact 16 is connected to the movable contact piece 15. The movable contact 16 faces the first fixed contact 12 and the second fixed contact 14. The movable contact 16 is disposed between the first fixed contact 12 and the second fixed contact 14.

In the following description, a direction from the terminal support portion 17 of the base 2 toward the contacts 12 and 16 is defined as upward, and the opposite direction is defined as downward. A direction from the movable contact 16 to the first fixed terminal 11 is defined as front, and the opposite direction is defined as rear. A direction perpendicular to the up-down direction and the front-rear direction is defined as the left-right direction, or lateral direction. The left and right directions toward the front are defined as left and right, respectively.

The coil block 4 is disposed behind the contact device 3. The coil block 4 includes a spool 21, a coil 22, an iron core 23, a yoke 24, an armature 25, and a hinge spring 26. The coil 22 is wound around the spool 21. A coil terminal 27 is connected to the coil 22. The iron core 23 is disposed in the spool 21. The yoke 24 is connected to the iron core 23 and the armature 25.

The armature 25 is rotatably supported around a lower end of the armature 25. The hinge spring 26 is connected to the armature 25. The hinge spring 26 is fitted between the base 2 and the yoke 24. The armature 25 is connected to the card 5. The hinge spring 26 is a plate spring and urges the armature 25 rearward. The base 2 includes a coil support portion 18. The coil support portion 18 supports the coil block 4.

The card 5 pushes the movable contact piece 15 to move the movable contact 16. The card 5 is made of resin. The card 5 is disposed above the coil block 4. The card 5 includes a connecting portion 31, guide rails 32 and 33, and a pressing portion 34. The connecting portion 31 is connected to the armature 25. As shown in FIG. 2, a concave groove 35 is provided in the upper portion of the armature 25. The connecting portion 31 is engaged to the armature 25 by being disposed in the concave groove 35.

The guide rails 32 and 33 are disposed between the connecting portion 31 and the pressing portion 34. The guide rails 32 and 33 are disposed above the coil block 4. The guide rails 32 and 33 extend forward from the connecting portion 31. The base 2 includes a card support portion 19. The card support portion 19 extends upward from the coil support portion 18. The guide rails 32 and 33 are supported by the card support portion 19. As the guide rails 32 and 33 slide on the card support portion 19, the card 5 moves forward and backward.

Specifically, the guide rails 32 and 33 include a first guide rail 32 and a second guide rail 33, as shown in FIG. 1. The first guide rail 32 and the second guide rail 33 are disposed apart from each other in the left-right direction. The card support portion 19 includes a first guide groove 36 and a second guide groove 37. The first guide groove 36 and the second guide groove 37 extend in the front-rear direction. The first guide rail 32 is disposed on the first guide groove 36. The second guide rail 33 is disposed on the second guide groove 37. The first guide rail 32 slides on the first guide groove 36. The second guide rail 33 slides on the second guide groove 37. As a result, the card 5 moves forward and backward.

The pressing portion 34 protrudes toward the movable contact piece 15. The pressing portion 34 is configured to press the movable contact piece 15. The pressing portion 34 includes a first pressing portion 38, a second pressing portion 39, and a connecting portion 40. The first pressing portion 38 and the second pressing portion 39 are disposed apart from each other in the left-right direction. The first pressing portion 38 extends from the first guide rail 32 toward the movable contact piece 15. The second pressing portion 39 extends from the second guide rail 33 toward the movable contact piece 15. The connecting portion 40 extends in the left-right direction. The connecting portion 40 connects the first pressing portion 38 and the second pressing portion 39.

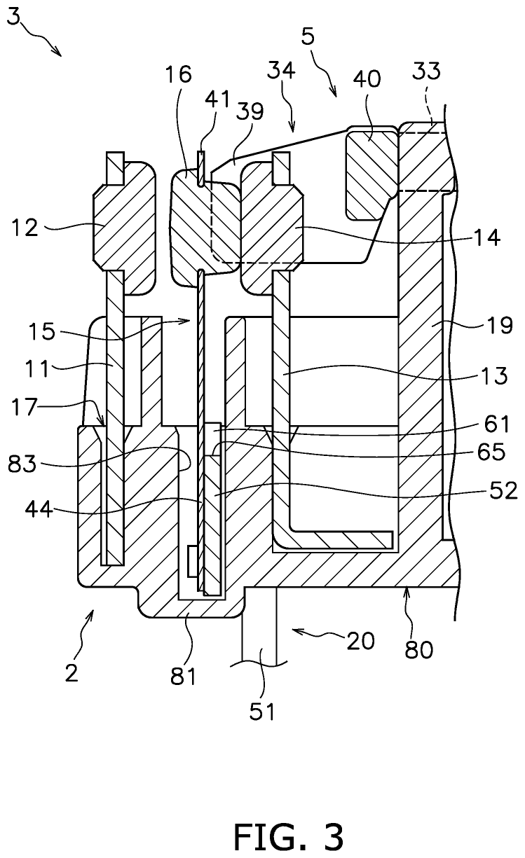

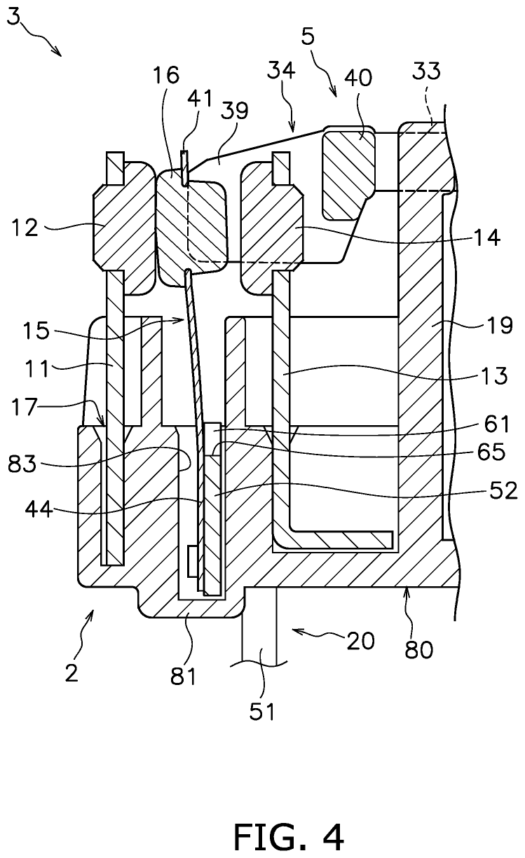

Next, operation of the electromagnetic relay 1 will be described. FIGS. 3 and 4 are side cross-sectional views of the electromagnetic relay 1 in the vicinity of the contact device 3. When the coil 22 is not energized, the biasing force of the hinge spring 26 separates the armature 25 from the iron core 23 as shown in FIG. 2. In this state, the movable contact 16 is separated from the first fixed contact 12 and contacts the second fixed contact 14, as shown in FIG. 3.

When the coil 22 is energized and excited, the armature 25 is attracted to the iron core 23 by magnetic force. As a result, the armature 25 rotates around the lower end, and the upper portion of the armature 25 moves forward. As the armature 25 moves, the card 5 moves forward, and the pressing portion 34 presses the movable contact piece 15 forward. As a result, as shown in FIG. 4, the movable contact piece is elastically deformed forward, and the movable contact 16 is moved forward. As a result, the movable contact 16 moves away from the second movable contact 16 and contacts the first fixed contact 12.

When the energization of the coil 22 is stopped and the coil 22 is demagnetized, the biasing force of the hinge spring 26 separates the armature 25 from the iron core 23 as shown in FIG. 2. That is, the upper portion of the armature 25 moves rearward by rotating the armature 25 around the lower end. As the armature 25 moves, the card 5 moves backward. As a result, the movable contact 16 is separated from the first fixed contact 12 and contacts the second fixed contact 14, as shown in FIG. 3.

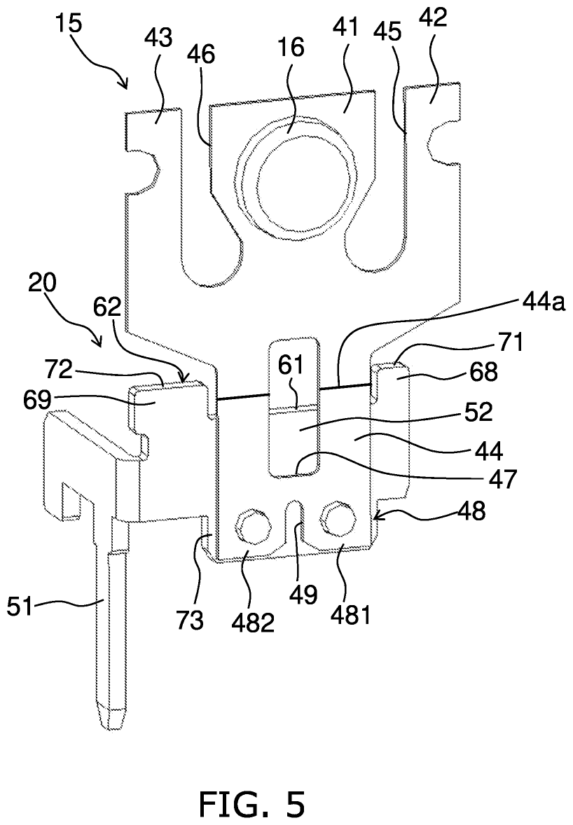

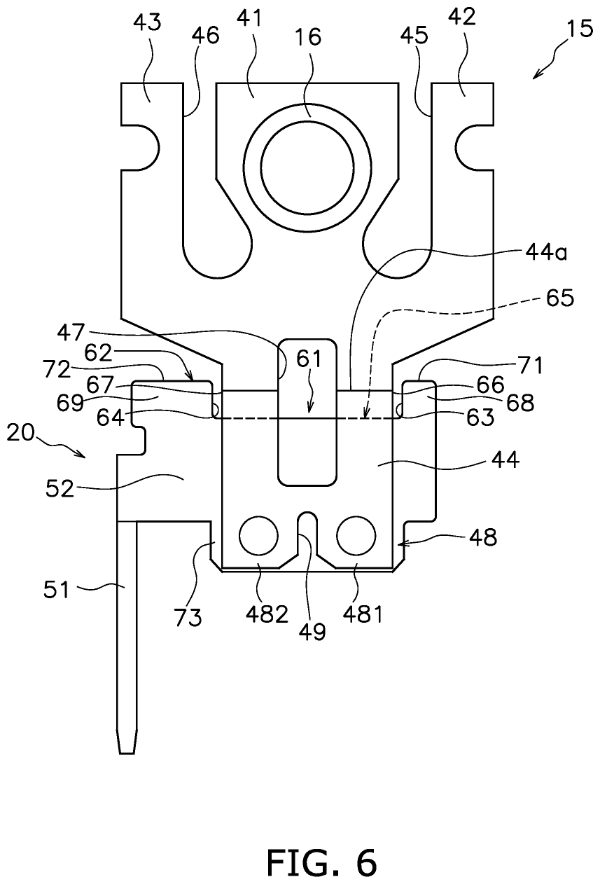

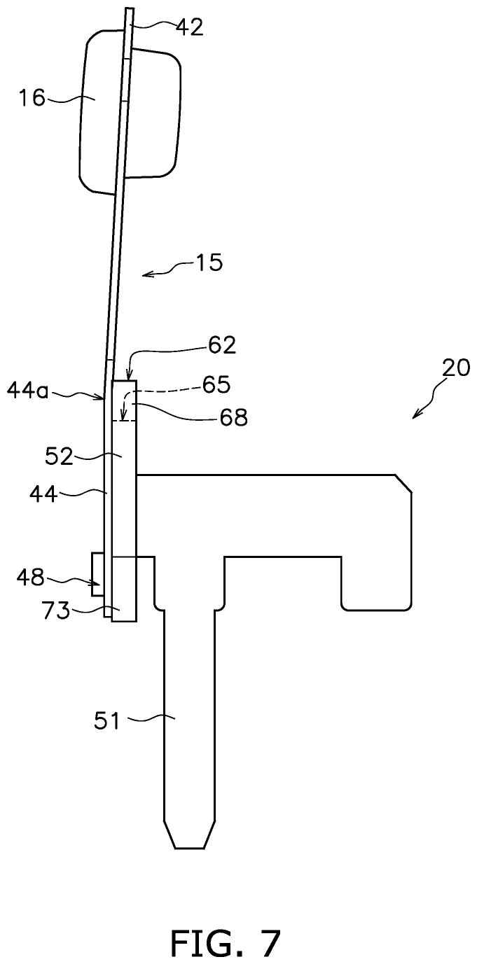

Next, the movable terminal 20 and the movable contact piece 15 will be described in detail. FIG. 5 is a perspective view of the movable terminal 20 and the movable contact piece 15. FIG. 6 is a front view of the movable terminal 20 and the movable contact piece 15. FIG. 7 is a side view of the movable terminal 20 and the movable contact piece 15. As shown in FIGS. 5 and 6, the movable contact piece 15 is provided separately from the movable terminal 20 and attached to the movable terminal 20. The movable contact piece 15 includes a contact connection portion 41, a first receiving portion 42, a second receiving portion 43, and an extending portion 44. The movable contact 16 is attached to the contact connection portion 41. The contact connection portion 41 is disposed between the first receiving portion 42 and the second receiving portion 43.

The first receiving portion 42 is disposed on one side of the contact connection portion 41. The second receiving portion 43 is disposed on the other side of the contact connection portion 41. A first slit 45 is provided between the contact connection portion 41 and the first receiving portion 42. A second slit 46 is provided between the contact connection portion 41 and the second receiving portion 43. The first receiving portion 42 is pressed by the first pressing portion 38 of the card 5. The second receiving portion 43 is pressed by the second pressing portion 39 of the card 5.

The extending portion 44 is disposed below the contact connection portion 41. The extending portion 44 is connected to the contact connection portion 41, the first receiving portion 42, and the second receiving portion 43. The extending portion 44 extends downward from the contact connection portion 41. The extending portion 44 includes an opening 47. The opening 47 extends in the vertical direction.

The extending portion 44 includes a bent portion 44a. The extending portion 44 has a bent shape at the bent portion 44a. The bent portion 44a extends in the left-right direction at the extending portion 44. The movable contact piece 15 is inclined upward and rearward from the bent portion 44a. That is, the movable contact piece 15 is inclined toward the second fixed contact 14 at a portion above the bent portion 44a. Since the movable contact piece 15 has a bent shape, in a case where the coil 22 is not energized, the movable contact piece 15 presses the movable contact 16 toward the second fixed contact 14 by the elastic force of the movable contact piece 15. Thereby, the contact force between the movable contact 16 and the second fixed contact 14 is obtained.

The extending portion 44 includes a fixing portion 48. The movable contact piece 15 is fixed to the movable terminal 20 at the fixing portion 48. The fixing portion 48 is fixed to the movable terminal 20 by caulking or welding, for example. The fixing portion 48 includes a first fixing portion 481 and a second fixing portion 482. A slit 49 is provided between the first fixing portion 481 and the second fixing portion 482. The slit 49 extends upward from the lower edge of the extending portion 44.

The movable terminal 20 includes a terminal portion 51 and a support portion 52. The terminal portion 51 is fixed to the base 2 by press fitting or adhesion. As shown in FIG. 3, the terminal portion 51 protrudes downward from the bottom surface 80 of the base 2 through the base 2. The support portion 52 is connected to the movable contact piece 15 below the movable contact 16. The support portion 52 overlaps the extending portion 44 in the front-rear direction and is in contact with the extending portion 44. The support portion 52 is fixed to the fixing portion 48 of the extending portion 44.

The support portion 52 includes a recess 61. The recess 61 has a shape recessed downward from the upper edge 62 of the support portion 52 at a position overlapping the extending portion 44. The width of the recess 61 is greater than the width of the movable contact piece 15 at the position overlapping the recess 61. That is, the width of the recess 61 is greater than the width of the extending portion 44. The width of the recess 61 means the length of the recess 61 in the left-right direction. The width of the extending portion 44 means the length of the extending portion 44 in the left-right direction.

The recess 61 overlaps the opening 47 of the extending portion 44. As shown in FIG. 6, the recess 61 includes a first inner side surface 63, a second inner side surface 64, and a bottom surface 65. The extending portion 44 includes a first outer side surface 66 and a second outer side surface 67. As seen from the front-rear direction, the first inner side surface 63 of the recess 61 is disposed with a gap from the first outer side surface 66 of the extending portion 44. As seen from the front-rear direction, the second inner side surface 64 of the recess 61 is disposed with a gap from the second outer side surface 67 of the extending portion 44. The bottom surface 65 of the recess 61 overlaps the extending portion 44 as seen from the front-rear direction.

As shown in FIG. 6, as seen in a front view of the movable contact piece 15, the bent portion 44a of the extending portion 44 is positioned in the recess 61. The bent portion 44a of the extending portion 44 faces the recess 61. The bent portion 44a of the extending portion 44 is positioned below the upper edge 62 of the support portion 52. The bent portion 44a of the extending portion 44 is located above the bottom surface 65 of the recess 61.

The support portion 52 includes a first protrusion 68 and a second protrusion 69. The first protrusion 68 is disposed on one side of the recess 61. The first protrusion 68 protrudes upward from the recess 61. The first protrusion 68 includes a flat first upper end 71. The second protrusion 69 is disposed on the other side of the recess 61. The second protrusion 69 protrudes upward from the recess 61. The second protrusion 69 includes a flat second upper end 72.

The support portion 52 includes a lower convex portion 73. The lower convex portion 73 has a shape protruding downward. The lower convex portion 73 is fixed to the fixing portion 48. The extending portion 44 of the movable contact piece is fixed to the movable terminal 20 at the lower convex portion 73.

As shown in FIG. 2, the base 2 includes a first stand portion 81 and a second stand portion 82. The first stand portion 81 and the second stand portion 82 protrude downward from the bottom surface 80 of the base 2. When the electromagnetic relay 1 is attached to the substrate, the first stand portion 81 and the second stand portion 82 contact the substrate. Thereby, a gap is provided between the bottom surface 80 of the base 2 and the surface of the substrate.

As shown in FIG. 3, the terminal support portion 17 of the base 2 includes a concave groove 83. The concave groove 83 is disposed directly above the first stand portion 81. The concave groove 83 has a downwardly recessed shape. The support portion 52 is disposed in the concave groove 83. The bottom surface of the concave groove 83 is positioned below the bottom surface 80 of the base 2. At least part of the recess 61 of the support portion 52 is disposed in the concave groove 83. The bottom surface 65 of the recess 61 is disposed below the upper end of the concave groove 83.

In the electromagnetic relay 1 according to the present embodiment described above, the support portion 52 of the movable terminal 20 has the recess 61 at the position overlapping the movable contact piece 15. Therefore, the length of the portion of the movable contact piece 15 that can be elastically deformed by pressing with the card 5 is increased while suppressing an increase in the height of the movable contact piece 15 with respect to the base 2. For example, as shown in FIG. 6, when the card 5 presses the movable contact piece 15, the portion of the movable contact piece above the bottom surface 65 of the recess 61 is elastically deformed. Therefore, the length of the portion of the movable contact piece 15 located above the support portion 52 is increased as compared with the case where the recess 61 is not provided. As a result, the length of the elastically deformable portion of the movable contact piece 15 is increased while suppressing an increase in the size of the electromagnetic relay 1 in the vertical direction. As a result, in the movable contact piece 15, the spring constant of the movable contact piece 15 that satisfies the electrical switching performance of the electromagnetic relay 1 is ensured.

Since the support portion 52 of the movable terminal 20 has the recess 61, the bent portion 44a of the movable contact piece 15 can be disposed at a low position. Therefore, the length of the portion of the movable contact piece 15 above the bent portion 44a is increased. As a result, the length of the elastically deformable portion of the movable contact piece 15 is increased while suppressing an increase in the size of the electromagnetic relay 1 in the vertical direction. Moreover, due to the bent shape of the movable contact piece 15, the movable contact piece 15 presses the movable contact 16 against the fixed contact 14 when the coil 22 is not energized. In this state, contact force for stably maintaining contact between the movable contact 16 and the fixed contact 14 is obtained by the spring constant of the movable contact piece 15.

Although one embodiment of the present invention has been described above, the present invention is not limited to the above-described embodiment, and various modifications are possible without departing from the gist of the invention.

The structure of the coil block 4 is not limited to that of the above embodiment, and may be modified. For example, in the embodiment described above, the direction of the axis of the coil 22 coincides with the direction of movement of the card 5. However, the direction of the axis of the coil 22 may be different from the moving direction of the card 5.

The structure of the contact device 3 is not limited to that of the above embodiment, and may be modified. For example, the second fixed terminal 13 and the second fixed contact 14 may be omitted. Alternatively, the first fixed terminal 11 and the first fixed contact 12 may be omitted. The first fixed contact 12 may be provided separately from or integrated with the first fixed terminal 11. The second fixed contact 14 may be provided separately from or integrated with the second fixed terminal 13. The movable contact 16 may be provided separately from or integral with the movable contact piece 15.

The structure of the card 5 is not limited to that of the above embodiment, and may be modified. For example, in the above embodiment, the card 5 is slidably supported on the base 2. However, the card 5 may be rotatably supported by the base 2. The card 5 may be rotated by being pressed by the armature 25.

The shape of the movable contact piece 15 is not limited to that of the above embodiment, and may be changed. For example, the movable contact piece 15 may have a linear shape extending vertically. The movable contact piece 15 may have a flat shape without the bent portion 44a.

### REFERENCE NUMERALS

11: First fixed terminal, 2: Base, 12: First fixed contact, 15: Movable contact piece, 16: Movable contact, 20: Movable terminal, 52: Support portion, 61: Recess, 62: Upper edge of support portion, 65: Bottom surface, 68: First protrusion, 69: Second protrusion, 71: First upper end, 72: Second upper end, 81: First stand portion, 83: Concave groove

1. An electromagnetic relay comprising:
a fixed terminal;
a base that supports the fixed terminal;
a fixed contact connected to the fixed terminal;
a movable contact that faces the fixed contact;
a movable contact piece to which the movable contact is connected; and
a movable terminal supported by the base, the movable terminal being provided separately from the movable contact piece, the movable terminal including a support portion that supports the movable contact piece, the support portion being connected to the movable contact piece below the movable contact,
the support portion including
an upper edge, and
a recess having a shape recessed downward from the upper edge at a position overlapping the movable contact piece.

2. The electromagnetic relay according to claim 1, wherein
a width of the recess is greater than a width of the movable contact piece at a position overlapping the recess.

3. The electromagnetic relay according to claim 1, wherein
the support portion includes a first protrusion disposed on one side of the recess and protruding upward from the recess.

4. The electromagnetic relay according to claim 3, wherein
the first protrusion includes a first upper end having a flat shape.

5. The electromagnetic relay according to claim 3, wherein
the support portion includes a second protrusion disposed on another side of the recess and protruding upward from the recess.

6. The electromagnetic relay according to claim 5, wherein
the second protrusion includes a second upper end having a flat shape.

7. The electromagnetic relay according to claim 1, wherein
the base includes
a bottom surface,
a stand portion protruding downward from the bottom surface, and
a concave groove disposed above the base and having a shape recessed downward, and
the support portion is disposed in the concave groove.

8. The electromagnetic relay according to claim 1, wherein
the movable contact piece includes a bent portion and has a bent shape at the bent portion, and
the bent portion is disposed to face the recess.

9. The electromagnetic relay according to claim 8, wherein
a portion of the movable contact piece above the bent portion is inclined toward the fixed contact.
